(19) United States
(12) Patent Application Publication
(10) Pub. No.: US 2026/0213474 A1
(43) Pub. Date: Jul. 23, 2026

(54) LINE CONNECTOR

(71) Applicant: Furuno Electric Co., Ltd., Nishinomiya-City (JP)

(72) Inventor: Takehiro KISHIDA, Sanda (JP)

(73) Assignee: Furuno Electric Co., Ltd., Nishinomiya-City (JP)

(21) Appl. No.: 19/564,267

(22) Filed: Mar. 12, 2026

Related U.S. Application Data
(63) Continuation of application No. PCT/JP2024/026522, filed on Jul. 24, 2024.

(30) Foreign Application Priority Data
Sep. 21, 2023 (JP) 2023-156213

(51) Int. Cl. H01R 24/50; H01R 12/71

(52) U.S. Cl. CPC H01R 24/50; H01R 12/716

(57) ABSTRACT

A line connector is provided with a coaxial connector having a core wire, a coaxial connector body covering the outer periphery of the core wire, and a substrate having a first main surface and a second main surface provided on the opposite side of the first main surface of the substrate. The coaxial connector body is arranged opposite to the second main surface of the substrate. The substrate includes a microstrip line including a region on the first main surface of the substrate, and a conductive pattern connecting the microstrip line to a protrusion of the core wire protruding from the first main surface of the substrate.

### CROSS-REFERENCE TO RELATED APPLICATIONS

This application is a bypass continuation of International Application No. PCT/JP2024/026522, filed on Jul. 24, 2024, which claims priority to Japanese Patent Application No. 2023-156213, filed on Sep. 21, 2023. The entire contents of the above applications are incorporated herein by reference.

### TECHNICAL FIELD

The present invention relates to a line connector.

### BACKGROUND

A line connector for electrically connecting a core wire of a coaxial connector to a microstrip line provided on a substrate has been developed. For example, conventional art discloses the following technology in which an attachment structure of a connector for connecting a coaxial cable is such that the connector for connecting the coaxial cable is attached to a printed circuit board having a microstrip line and a ground conductor, a notch is provided at the end of the printed circuit board, the connector for connecting the coaxial cable is attached to the notch. The center conductor (core wire) of the coaxial cable held in the connector for connecting the coaxial cable is connected to the microstrip line, and an external conductor of the coaxial cable is connected to the ground conductor through the notch.

### SUMMARY

In the technique described in the above conventional art, a core wire extending in the longitudinal direction of a substrate is electrically connected to a microstrip line. In this case, the degree of freedom in the arrangement of the line connectors may be reduced.

The present invention has been made to solve the above-mentioned problems, and its object is to provide a line connector capable of improving the degree of freedom in the arrangement.

In order to solve the above problem, a line connector according to a certain aspect of the present invention is provided with a coaxial connector having a core wire and a coaxial connector body covering an outer periphery of the core wire; and a substrate having a first main surface and a second main surface provided on the opposite side of the first main surface of the substrate. The coaxial connector body is arranged opposite to the second main surface of the substrate. The substrate includes a microstrip line including a region on the first main surface of the substrate, and a conductive pattern connecting the microstrip line to a protrusion of the core wire protruding from the first main surface of the substrate.

For example, a coaxial cable connected to a coaxial connector is difficult to bend because of its high rigidity. Therefore, when the line connector is arranged in a device, it is easy to be constrained in the arrangement to avoid interference with other components. As described above, in the thickness direction of the substrate, the core wire of the coaxial connector protrudes from the first main surface of the substrate by penetrating the substrate, and a portion of the core wire protruding from the first main surface is electrically connected to the microstrip line, so that the length of the line connector in the longitudinal direction of the substrate can be shortened compared with the configuration in which the core wire extending in the longitudinal direction of the substrate is electrically connected to the microstrip line. Therefore, a degree of freedom in the arrangement of the line connector can be improved.

According to the above aspect, when a length of the protrusion in an extension direction of the core wire is L and a wavelength of electromagnetic waves propagated in the core wire and the microstrip line is λ, L may satisfy the following equation (1):

$$0 \leq L < λ / 4. \qquad ( 1 )$$

With such a configuration, it is possible to reduce the length of the portion of the core wire protruding from the first main surface of the substrate while suppressing the deterioration of the propagation characteristics of the electromagnetic waves, thereby reducing an impedance mismatch between the core wire and the microstrip line.

According to any of the above aspects, the coaxial connector body may be arranged apart from the second main surface of the substrate.

With such a configuration, the length of the portion protruding from the first main surface of the substrate in the core wire, which is a predetermined length according to the specification of the coaxial connector, can be reduced, and therefore, the impedance mismatch between the core wire and the microstrip line can be reduced.

According to any of the above aspects, a width of the conductive pattern is greater than a width of the microstrip line and less than or equal to a diameter of the core wire.

With such a configuration, the impedance matching between the core wire and the microstrip line can be adjusted, thereby reducing the impedance mismatch caused by the difference between the diameter of the core wire and the width of the microstrip line.

According to the above aspect, the line connector may further include a case configured to support the substrate, and the case may be spaced from a region of the second main surface at a position corresponding to the conductive pattern.

By adjusting the width of the conductive pattern connecting the core wire and the microstrip line and by arranging the case configured to support the substrate at a distance from a region of the second main surface at a position corresponding to the conductive pattern, the impedance mismatch between the core wire and the microstrip line can be reduced more effectively.

According to the above aspect, the case may include a notch provided at a position opposing the conductive pattern on a surface opposing the second main surface.

With such a configuration, an interval for adjusting the impedance matching can be easily formed between the case and a position corresponding to the conductive pattern on the second main surface.

According to any of the above aspects, the substrate may electrically connect the first main surface of the substrate to the second main surface of the substrate and include a via surrounding a portion of the core wire.

With such a configuration, for example, a portion of the core wire protruding from the first main surface of the substrate can be shielded, so that leakage of an electric field of the electromagnetic waves propagating through the core wire can be suppressed.

According to the present invention, it is possible to provide a line connector capable of improving a degree of freedom of arrangement.

### BRIEF DESCRIPTION OF DRAWINGS

FIG. 1 is a side view schematically showing a configuration of a line connector according to an embodiment of the present invention.

FIG. 2 is a cross-sectional view showing a section along a line II-II in FIG. 1 of the line connector according to an embodiment of the present invention.

FIG. 3 is a plan view schematically showing a configuration of the line connector according to an embodiment of the present invention.

FIG. 4 is a plan view showing a configuration of a case of the line connector according to an embodiment of the present invention.

FIG. 5 is a cross-sectional view showing an enlarged area near a hole in the case in FIG. 2.

FIG. 6 is a diagram showing an example of a measurement result of the S-parameter in the line connector according to an embodiment of the present invention.

FIG. 7 is a diagram showing an example of a measurement result of the S-parameter in the line connector according to a comparative example.

### DESCRIPTION OF EMBODIMENTS

The embodiments of the present invention will now be described with reference to the drawings. In the present specification and the figures, elements like those described above with respect to the previous figures may be denoted by the same reference numerals, and detailed descriptions may be omitted accordingly. In addition, at least one of the following embodiments may be optionally combined.

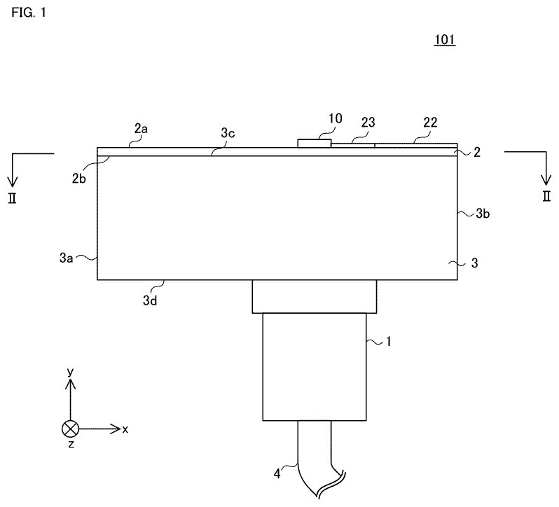

FIG. 1 is a side view schematically showing a configuration of a line connector according to an embodiment of the present invention. Referring to FIG. 1, a line connector 101 includes a coaxial connector 1, a substrate 2, and a case 3. The coaxial connector 1 is connected to the coaxial cable 4.

The line connector 101 is provided, for example, in a radar device for monitoring a floating object such as a ship. Specifically, for example, the line connector 101 is provided to extract a portion of the electromagnetic waves E transmitted from the transmitter as the electromagnetic waves for power monitoring in the radar device.

The shape of the case 3 is, for example, a rectangular parallelepiped. The case 3 includes a first end 3a and a second end 3b. The case 3 supports the substrate 2. The material of the case 3 is, for example, a metal.

The substrate 2 is, for example, a printed wiring board. The substrate 2 has a first main surface 2a and a second main surface 2b provided on the opposite side of the first main surface 2a.

The case 3 has a first main surface 3c opposed to the second main surface 2b of the substrate 2 and a second main surface 3d provided on the opposite side of the first main surface 3c.

An axis parallel to the longitudinal direction of the case 3 and oriented from the first end 3a to the second end 3b of the case 3 is defined as an x-axis. An axis perpendicular to the x-axis is defined as a y-axis. The y-axis is oriented vertically upward, for example. An axis perpendicular to both the x-axis and the y-axis is defined as a z-axis. The z-axis has an orientation such that the x-axis, the y-axis and the z-axis form the coordinate axis of the right-hand system.

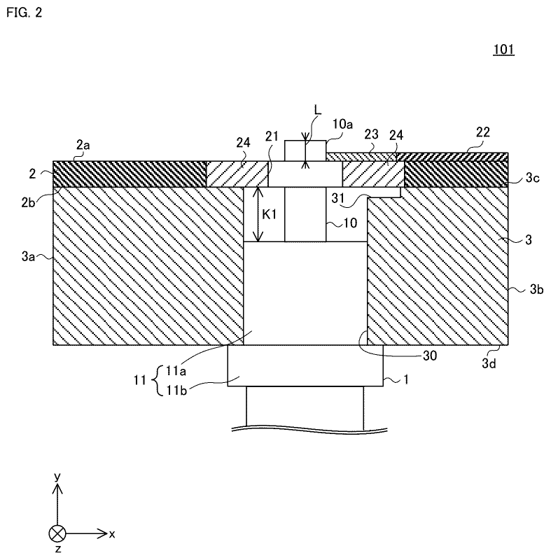

FIG. 2 is a cross-sectional view showing a cross section along a line II-II in FIG. 1 of the line connector according to an embodiment of the present invention. Referring to FIGS. 1 and 2, the coaxial connector 1 includes a core wire 10 and a coaxial connector body 11 covering the outer periphery of the core wire 10.

The core wire 10 extends in the thickness direction of the substrate 2, i.e., in the y-axis direction. The core wire 10 propagates the electromagnetic waves E. Specifically, for example, the core wire 10 propagates the electromagnetic waves E in the X-band (8 GHz to 12 GHz) as a band. The frequency of the electromagnetic waves E is not limited to the frequency of the X-band but may alternatively be in another frequency band.

The coaxial connector body 11 includes a cylinder 11a and a flange 11b. The cylinder 11a covers a portion of the core wire 10. The material of the cylinder 11a is, for example, polytetrafluoroethylene (PTFE). The cylinder 11a is fitted into a hole 30 provided in the case 3.

The flange 11b is fixed to a bottom surface of the cylinder 11a. The flange 11b is fixed to the case 3 by a fixing member such as a screw, for example, while the cylinder 11a is fitted into the hole 30.

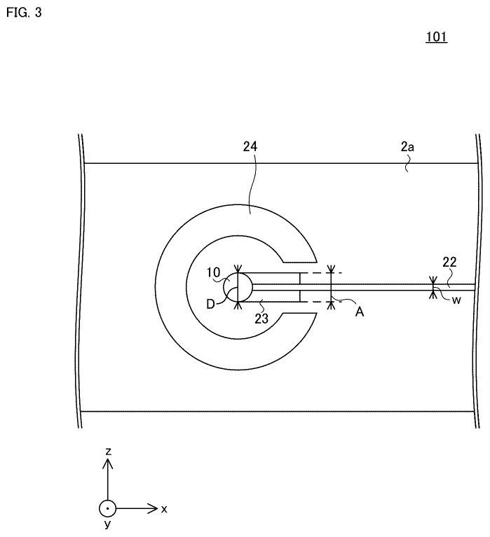

FIG. 3 is a plan view schematically showing a configuration of the line connector according to an embodiment of the present invention. Referring to FIGS. 1 to 3, the core wire 10 of the coaxial connector 1 protrudes from the first main surface 2a of the substrate 2 by penetrating the substrate 2.

Specifically, for example, a through hole 21 through which the core wire 10 penetrates is formed in the substrate 2. The core wire 10 protrudes from the first main surface 2a while penetrating the through hole 21.

The substrate 2 constitutes a microstrip line 22 including a region on the first main surface 2a. For example, the microstrip line 22 propagates the electromagnetic waves E. In the line connector 101, the core wire 10 constitutes an input port and the microstrip line 22 constitutes an output port.

For example, the substrate 2 includes a conductive pattern 23 provided on the first main surface 2a. The conductive pattern 23 connects the microstrip line 22 and a portion 10a (hereinafter referred to as “protrusion”) of the core wire 10 protruding from the first main surface 2a.

For example, in a plan view (i.e., viewed from above), the conductive pattern 23 has an elongated rectangular shape extending in the x-axis direction. When the width of the conductive pattern 23 is A, the diameter of the core wire 10 is D, and the width of the microstrip line 22 is W, the width A is larger than the width W and less than or equal to the diameter D. For example, the width A of the conductive pattern 23 is adjusted so that the impedance of the conductive pattern 23 is 50 ohms. The shape of the conductive pattern 23 may be trapezoidal in the plan view.

When L is the length of the protrusion 10a in the extending direction of the core wire 10 and λ is the wavelength of the electromagnetic waves E, the length L satisfies the following equation (1):

$$0 \leq L < λ / 4. \qquad ( 1 )$$

For example, in the coaxial connector 1, the coaxial connector body 11 is disposed at a distance K1 from the second main surface 2b of the substrate 2. Specifically, for example, the cylinder 11a of the coaxial connector body 11 is disposed at a distance K1 from the second main surface 2b.

For example, the substrate 2 further includes a via 2l electrically connecting the first main surface 2a to the second main surface 2b and enclosing a portion of the core wire 10. Specifically, for example, the via 24 surrounds a portion of the core wire 10 penetrating the substrate 2 between the first main surface 2a and the second main surface 2b. For example, the shape of the via 24 is C-shaped in the plan view.

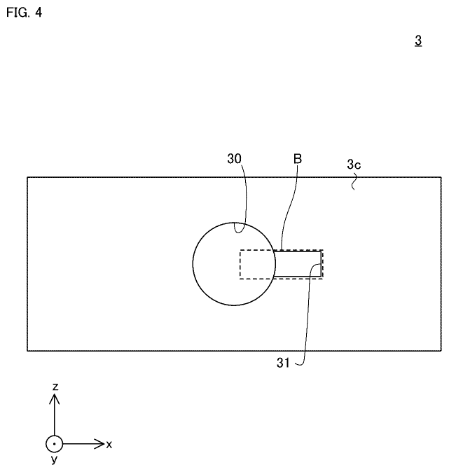

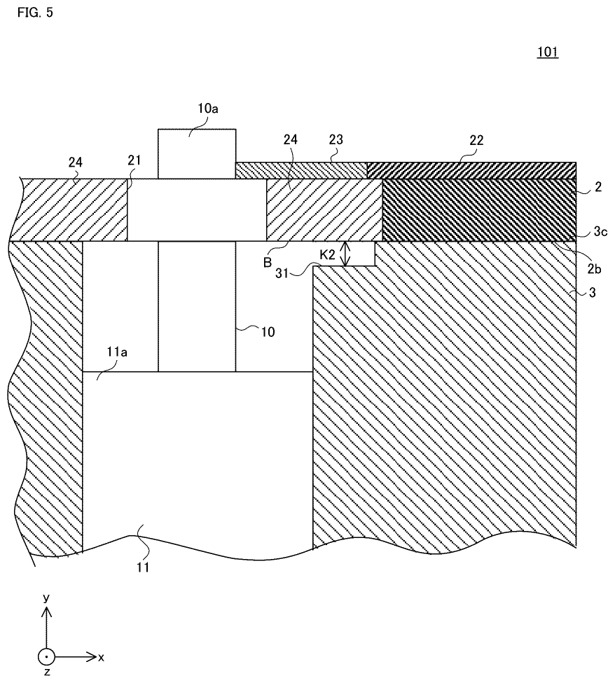

FIG. 4 is a plan view showing a configuration of the case of the line connector according to an embodiment of the present invention. FIG. 5 is an enlarged cross-sectional view showing the vicinity of a hole of the case in FIG. 2. Referring to FIGS. 4 and 5, the case 3 includes a notch 31 provided on the first main surface 3c.

More specifically, for example, the notch 31 is provided at a position corresponding to the conductive pattern 23 of the substrate 2 on the first main surface 3c.

Specifically, for example, the notch 31 is provided at a position overlapping the conductive pattern 23 in the plan view on the first main surface 3c. For example, the shape of the notch 31 is rectangular in the plan view.

Since the notch 31 is provided on the first main surface 3c, the case 3 is arranged at a distance K2 from a region B of the second main surface 2b at a position corresponding to the conductive pattern 23.

Specifically, for example, on the second main surface 2b, the region B corresponds to a position overlapping the conductive pattern 23 in the plan view.

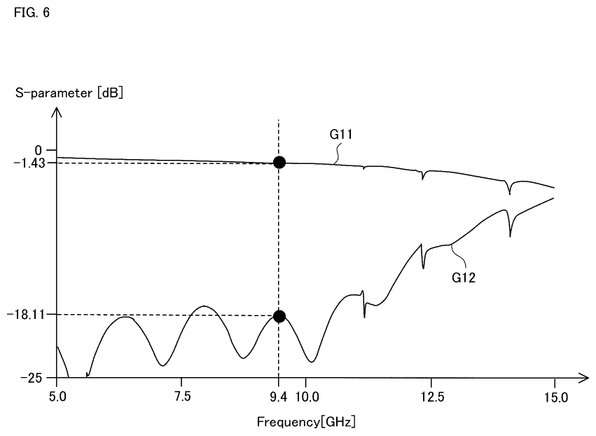

FIG. 6 is a diagram showing an example of a measurement result of an S-parameter in a line connector according to an embodiment of the present invention. In FIG. 6, a horizontal axis indicates the frequency [GHz]

Referring to FIG. 6, in the graph G11, when the frequency of the electromagnetic waves E is 9.4 GHz, the intensity S21 of the electromagnetic waves E is −1.43 dB. In the graph G12, when the frequency of the electromagnetic waves E is 9.4 GHz, the intensity S11 of the electromagnetic waves E is −18.11 dB.

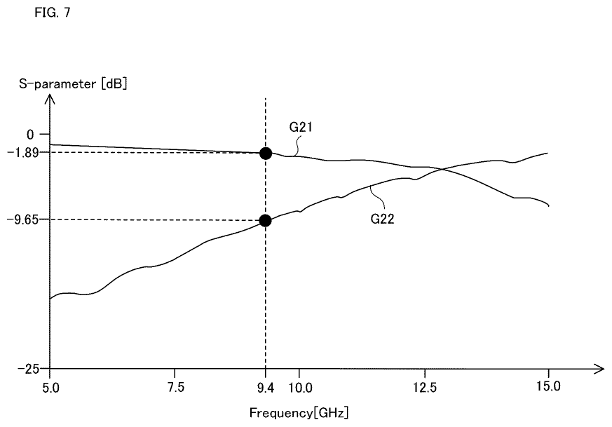

FIG. 7 is a diagram showing an example of the measurement result of the S-parameter in the line connector according to the comparative example. In FIG. 7, the horizontal axis indicates the frequency [GHz].

Referring to FIG. 7, in the graph G21, when the frequency of the electromagnetic waves E is 9.4 GHz, the intensity S21 of the electromagnetic waves E is −1.89 dB. In the graph G22, when the frequency of the electromagnetic waves E is 9.4 GHz, the intensity S11 of the electromagnetic waves E is −9.65 dB. Thus, when the frequency of the electromagnetic waves E is 9.4 GHz, the intensity S21 of the line connector 101 is closer to 0 than the intensity S21 of the line connector according to the comparative example. When the frequency of the electromagnetic waves E is 9.4 GHz, the absolute value of the intensity S11 of the line connector 101 is larger than the absolute value of the intensity S11 of the line connector according to the comparative example. That is, in the line connector 101, the power loss is smaller than that of the line connector according to the comparative example, and the intensity of the electromagnetic waves E that can be output can be increased.

It should be considered that the above embodiment is an example in all respects and not a limitation. It is intended that the scope of the present invention be indicated by the claims rather than the above description and include all changes within the meaning and scope of the claims and equivalence.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed. Unless otherwise explicitly stated, numbers preceded by a term such as “approximately,” “about,” and “substantially” as used herein include the recited numbers, and also represent an amount close to the stated amount that still performs a desired function or achieves a desired result.

For example, unless otherwise explicitly stated, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims..

What is claimed is:

1. A line connector comprising:
a coaxial connector having a core wire and a coaxial connector body covering an outer periphery of the core wire; and
a substrate having a first main surface and a second main surface provided on the opposite side of the first main surface of the substrate; wherein
the coaxial connector body is arranged opposite to the second main surface of the substrate;
the core wire protrudes from the first main surface by penetrating the substrate; and
the substrate comprises:
a microstrip line including a region on the first main surface; and
a conductive pattern connecting the microstrip line to a protrusion of the core wire protruding from the first main surface of the substrate.

2. The line connector according to claim 1, wherein:
L is a length of the protrusion in an extending direction of the core wire,
λ is a wavelength of the electromagnetic waves propagated in the core wire and the microstrip line, and
L satisfies the following equation:
$$0 \leq L < λ / 4.$$

3. The line connector according to claim 1, wherein:
the coaxial connector body is arranged apart from the second main surface of the substrate.

4. The line connector according to claim 2, wherein:
the coaxial connector body is arranged apart from the second main surface of the substrate.

5. The line connector of claim 1, wherein:
a width of the conductive pattern is greater than a width of the microstrip line and less than or equal to a diameter of the core wire.

6. The line connector of claim 2, wherein:
a width of the conductive pattern is greater than a width of the microstrip line and less than or equal to a diameter of the core wire.

7. The line connector of claim 5, further comprising:
a case configured to support the substrate, wherein:
the case is spaced from a region of the second main surface of the substrate at a position corresponding to the conductive pattern.

8. The line connector of claim 6, further comprising:
a case configured to support the substrate, wherein:
the case is spaced from a region of the second main surface of the substrate at a position corresponding to the conductive pattern.

9. The line connector of claim 7, wherein:
the case includes a notch provided at a position opposing the conductive pattern on a surface opposing the second main surface of the substrate.

10. The line connector of claim 8, wherein:
the case includes a notch provided at a position opposing the conductive pattern on a surface opposing the second main surface of the substrate.

11. The line connector of claim 1, wherein:
the substrate electrically connects the first main surface to the second main surface of the substrate, and includes a via surrounding a portion of the core wire.

12. The line connector of claim 2, wherein:
the substrate electrically connects the first main surface to the second main surface of the substrate, and includes a via surrounding a portion of the core wire.
